(19) United States
(12) Patent Application Publication
(10) Pub. No.: US 2006/0085117 A1
(43) Pub. Date: Apr. 20, 2006

(54) System for the control of multiple engines having independent throttle controls in a vehicle when driver becomes ineffective

(76) Inventor: Mark J. Stummer, Westlake (AU)

Correspondence Address: Francis Law Group, 1942 Embarcadero, Oakland, CA, 94606, US

(21) Appl. No.: 10/968,664

(22) Filed: Oct. 18, 2004

(51) Int. Cl. G06F 7/70

(52) U.S. Cl. 701/50; 701/1

(57) ABSTRACT

A system is provided for the throttle control of a multi-combination vehicle operable by a driver where said vehicle includes at least two engines each engine operable by an independent throttle. One of the throttles is controlled by a standard throttle pedal, the other by a hand-controlled throttle. If the driver becomes ineffective such as loosing consciousness, the second throttle is caused to be disregarded by the second engine that is forced to an idle position. Further, the second throttle can only become operable when the second throttle has been manually reset to a predetermined position, generally the idle position. A further improvement to the invention lies in the fact that under emergency braking the transmission system coupled with the second engine, generally automatic, is forced to convert mode to protect the transmission from damage.

### FIELD OF THE INVENTION

The present invention is directed to a throttle control system of a secondary engine in a vehicle where there are at least two engines, each engine being controlled by a separate throttle control and where the driver becomes ineffective, for example, losing consciousness. Typically the vehicle is a multi-combination vehicle including a truck and a power trailer. A standard pedal throttle provides the throttle control for one engine, generally the truck engine, whilst the throttle for the power trailer engine is provided by a separate throttle control, typically a hand throttle. The present invention is particularly useful in the case where the transmission systems of the truck and the power trailer may not be matched, such as the case where the truck transmission is a manual one and the power trailer transmission an automatic one. It is to be understood that the above invention is not limited to a multi-combination vehicle, it may also equally well apply to any vehicle having two or more engines even if it is only one vehicle having two engines.

### BACKGROUND OF THE INVENTION

Operators of heavy haulage products, such as mines, are constantly searching for ways to reduce the costs associated with hauling their product, in this case ore. One of the most significant costs in operating a mine is transporting the mined material from the ore face to a processing plant. This is exacerbated when the mined payload is of low grade, that is, the desired mineral or metal is only a small percentage by weight and/or volume of the mined ore so that substantial amounts of ore have to be handled to extract a small percentage of desired material. A further problem that occurs is where the ore has to be handled several times.

There are several ways that ore can be transported from the ore face to the processing plant, depending on the type and configuration of the mine.

Underground mines typically have a central lifting or winding shaft to bring the mined ore to the surface. These shafts require a dedicated receival point. To get the ore to that point mines typically have a dedicated rail system that is level and route specific. Underground mine haulage or dump trucks are used to transport the ore from various mining levels both above and below the rail haulage level to the dedicated rail system that then transports the ore to the lifting shaft receival point. The trucks are always a single unit that is either rigid or pivot steered. This type of arrangement has a number of distinct disadvantages.

The dump trucks cause a significant amount of hot air per ton of ore hauled to be exhausted into the mine. Cold ventilation air has to be continually pumped into the mine via ventilation shafts, and one of the major costs in establishing underground mines is the construction and drilling of ventilation shafts. Because of the limitation of currently known dump trucks, the time that they can operate underground is limited, particularly due to excess heat they produce. To reduce the heat, the dump trucks have to move relatively slowly.

A railway system, especially one underground, is relatively expensive to install and operate due to the cost of acquiring the locomotive and installing the fixed railway system and the associated maintenance costs. Furthermore the underground railway system being route-specific is not flexible to changes in route without incurring the expense of installing additional railway tracks. As each new mining area opens, it is necessary to incur the cost of installing new track for the railway system, or to use the dump trucks as described above whose efficiency decreases with the increasing distances they have to travel.

The central lifting or winding shaft is quite expensive, the cost running into tens of millions of dollars and is of a fixed location. As the mine expands the distance from the ore face to the central shaft becomes important in the cost of operating the mine.

In some instances mines have utilized conveyor belts instead of the railway system and/or the lifting shaft. The difficulty with conveyor belts is that once again they are route specific, and are quite expensive to install and maintain. Miners are also concerned that the belts may catch fire and starve the area of oxygen.

In some instances the dump trucks may be used to transport the ore directly above ground. Because of the limitations described above, especially low speed and the heat they produce, and with the inclination within underground mines generally being constant, the depth of a mine that can be realistically accessed by these dump trucks is therefore limited, typically to a depth of hundreds of metres.

When the ore has been transported to the surface, or in the case of an above ground mine, it is then necessary to transport the ore to a central processing plant.

One of the ways that this may be accomplished is by using conventional off-highway dump trucks than can either be a single rigid, pivot steer unit or an articulated vehicle consisting of a very short wheelbase earthmoving type of tractor unit coupled to a single hauled or carrying unit and virtually job specific. These units are designed to be a link in the chain of the actual mining, digging or producing the product. Their main function is to move product from the ore face to a receival point through the shortest possible distance, and they are not route-specific. The shorter the route the more economical they are. The ton of ore transported per distance costs increase dramatically over longer routes. They are therefore not suitable for hauling ore great distances, thereby limiting the distance that ore can be transported at a reasonable cost. As such, these trucks are not suitable when there may be satellite mines, that is, mines that are some distance away from the processing plant. In particular, these trucks have never been designed to be a transportation system for various reasons including the following:
(a) Their axle loadings are extreme and require appropriate roading and bridging. Wheeled or articulated dump trucks with large tires carry a significant loading per axle, up to 33 tons per axle.
(b) These types of trucks are designed for hauling loads over relatively short distances and rough terrain, have relatively large tires for relatively slow speed operation and are relatively expensive to operate and maintain due to fuel and tire costs.
(c) They produce too much heat in both their drive trains and tires. Furthermore they have poor power-to-weight ratios and low operating efficiencies.
(d) Their mass requires a large vehicle cross-section both in height and width.
(e) Their discharge methods are either: direct end-tip (non-captive) where the centre of gravity is always raised, or bottom-dump in the single articulated hauling vehicle that keeps the center of gravity down but is discharge-captive.

An alternate way of transporting the ore to a central processing plant includes conventional transportation systems such as conveyor belts systems and rail systems, both routes being captive. Problems with these systems have been discussed above.

Another way of transporting the ore is by using highway-type road vehicle combinations or multi-combination vehicles. These vehicles are limited by their horsepower, tractive or braking efforts or capacities, manufacturers' ratings of various componentry, directional stability behaviour, swept path characteristics, gradability and startability.

As a result, currently known systems for the extraction of ore from mines set limits on the commercial usefulness of mines simply due to the cost of transporting the ore.

As discussed above, multi-combination vehicles such as over-the-road vehicles are known. They include a truck coupled to a plurality of trailers and converter dollies. Until recently these vehicles have included a single power source, generally a diesel engine, with the vehicles being limited to a payload of some 170 tonnes, and a gradient not exceeding 5%. These multicombination vehicles, commonly referred to as “road-trains”, have been in use for some time, particularly in Australia, for the purpose of hauling mined products, or the commodities of other industries, over aboveground roadways. Conventional above-ground road-trains are typically designed for use at relatively high speed and on relatively flat ground. They are limited by their horse power, tractive or braking efforts and their capacities that are defined by manufacturers ratings, directional stability behaviour, swept path characteristics, gradability and startability. Accordingly they have limited uses for operation in mines.

The location of the mechanical couplings between each adjacent pair of vehicles in a multi-combination vehicle as described above is positioned to maintain the side-to-side sway, or yaw, of the last vehicle within acceptable limits for above-ground, over-the-road applications. The location is not compatible for operation within an underground mine due to the relatively low operating speeds as well as the relatively narrow tunnels and small radius bends found in underground mines.

Specially configured multi-combination vehicles have been developed recently which have a significantly reduced swept path width as compared to conventional aboveground road-trains. This enables these vehicles to be used to transport various payloads such as mined ores, over the roadways existing in an underground mine. U.S. Pat. No. 6,062,801 issued on May 16, 2000 and U.S. Pat. No. 6,361,269 issued on Mar. 26, 2002, each expressly incorporated by reference herein in its entirety, describe these specially configured multi-combination vehicles which may be used in underground mines. The vehicles can operate in a tunnel system with restricted height, width, swept paths and directional path and can comply with a predetermined behaviour pattern obviating the need for the rail or conveyor system.

Even after the advent of the foregoing specially configured multi-combination vehicles, various operational problems remained to be solved with regard to the transport of mined ores in both underground and above-ground applications. For instance, due to the heavy loads of the road-train combination, the traction provided by the powered wheels of a road-train, usually provided to two rear axles, was insufficient to satisfactorily negotiate the gradients associated with the declines providing ingress and egress to and from some underground mines. Alternatively, these declines into underground mines would have to be constructed at a much gentler slope leading to excessively long tunnels. In addition, the relatively low speed of the road trains underground due to the size of the tunnels and safety considerations results in road-trains travelling underground for a significant length of time, even up to an hour in some cases. This places strain on the road-train cooling system, which is typically designed for aboveground road-trains travelling at significant speeds, generally around 80 km/h. The engines are prone to overheating.

Also, before the introduction of multi-combinational vehicles incorporating a power trailer (i.e., one having a source of motive power), which are subsequently discussed in detail, multi-combination vehicles for dedicated road haulage such as mineral concentrate haulage operated at a 170 ton payload, as noted previously. However, there is a practical limit to the payload of the multi-combination vehicle with a single truck. Since the cost of haulage is determined mainly on weight, if one can increase the total haulage that can be moved by a single vehicle that does not require additional operators, the cost benefit is substantial. This is especially so if ore can be hauled directly from within a mine to a processing plant without needing to be reloaded onto another transport system.

In order to further improve multi-combination vehicles and provide even greater advantages to the operators using these vehicles, multi-combination vehicles have been developed which utilise a truck and an additional motive power source advantageously located within the chassis of a trailer and which include a unique cooling system that enables operation of the multi-combination vehicle at low speeds, on steeper gradients and with a greater payload than previously known. International Patent Application No. PCT/AU01/01154, expressly incorporated by reference herein in its entirety, discloses a multi-combinational vehicle including a power trailer having an engine that overcomes the foregoing problems of traction and cooling of such multi-combination vehicles. International Patent Application No. PCT/AU01/01568, also expressly incorporated by reference herein in its entirety, discloses various features that may be incorporated in the drive trains of multi-combination vehicles of this type. These multi-combination vehicles, which have the ability to traverse different mining levels, have removed the need for conventional dump truck haulage from the ore face to the rail head, and also have enabled the vehicle to haul ore directly from the ore face from any underground level via an access tunnel directly to a processing plant, thereby eliminating the need for the lifting shaft. Furthermore, these types of multi-combination vehicles coupled with specifically configured power trailers, typically B-double trailers, can be used above ground to transport ore directly to a processing plant eliminating the need for other dump trucks, increasing the total payload from some 170 tons to 270 tons whilst staying within the manufacturer's rating and at the same time increasing the general behaviour pattern, thereby creating a safer multi-combination vehicle.

Use of a multi-combination vehicle using a truck and a power trailer provides a further significant advantage over conventional single-engine dump trucks, and over multi-combination vehicles having only a truck. Even if one of the engines and/or transmissions fails there is the potential to use the second engine to at least move the multi-combination vehicle out of the way or even bring it to the surface for analysis and repair. As known in the art, in the event of engine and/or transmission failure it is more than a simple exercise to retrieve a single-engine dump truck from the depths of an underground mine that is then blocking the underground road from use by other trucks. A similar problem may exist with multi-combination vehicles powered only by a single truck, or in some instances a single prime mover.

International Patent Applications PCT/AU02/00667 and PCT/AU02/00668, disclose various features in a multi-combination vehicle of the type having two engines that enable at least one engine or transmission to operate and provide propulsion to the vehicle even if the other were to fail. These two applications discuss an arrangement whereby control of both of the engines is provided by a central control system, such as the throttle control pedal used by the driver. Accordingly they rely on the two engines and transmissions systems being generally of the same capacity and type, such as having identical automatic transmissions.

However, there may be instances where it may be desirable to provide a multi-combination vehicle combining a power trailer with an automatic transmission system to an existing truck running a manual transmission system. This is especially so if one considers that the majority of current trucks that are used in road-trains are ones utilising a manual transmission system.

One of the difficulties in such an arrangement is that the power trailer engine needs to be controlled by a separate control system rather than the truck throttle pedal. Coupling a power trailer running an automatic transmission to the existing truck throttle would not work. Every time the driver changed up a gear as the truck is accelerating they would remove throttle from the truck and trailer With no fuel received by the trailer engine the automatic transmission would gear down whilst the truck transmission would be geared up. When the truck higher gear is engaged, the trailer transmission is in the completely wrong gear causing undue stress on the trailer engine and the transmission.

For that reason it is necessary to provide for a separate trailer engine control that is operable by the driver independently of the truck engine.

However, having an independent control for the trailer engine is in itself a problem if for some reason the truck engine powers down very quickly or the driver applies heavy or emergency braking. In an emergency the normal procedure is for the driver to apply the foot brake. However, the power trailer engine continues to operate according to its throttle position independent of the application of the foot brake by the driver. This causes the power trailer engine to keep applying propulsion even where the driver has initiated emergency braking. For that reason, in International Patent Application titled “System for the control of multiple engines in a multi-combination vehicle having independent throttle controls when under emergency braking” the applicant disclosed a system whereby if the driver were to apply emergency braking by using the brake pedal and thereby removing their foot from the throttle pedal, the power trailer engine is caused to idle so that it does not provide a propulsion force to the multi-combination vehicle.

However, there may be instance where the driver becomes ineffective, by being injured or loosing consciousness. Under those circumstances typically the driver no longer throttles the foot pedal retuning the truck engine to idle. However, the power trailer, having an independent throttle control, continues at its preset throttle providing propulsion to the multi-combination vehicle, which is now in a runaway mode.

The inventor is unaware of any multicombination vehicle having a truck and a powered trailer with automatic transmissions, whether it is for above ground or underground use of the type described above, where the throttle control for each engine is independent and where the power trailer engine throttle is disengaged or bypassed when the throttle for the truck returns to idle.

The inventor is further unaware of any multicombination vehicle having a manual transmission truck and a powered trailer, whether it is for above ground or underground use of the type described above, where the throttle control for each engine is independent and where the power trailer engine throttle is disengaged or bypassed when the throttle for the truck returns to idle, but with the trailer engine throttle disengaged only after a preset amount of time. The preset amount of time allows the driver to change gears in the truck without forcing the power trailer engine to idle, since changing gears requires the driver to remove their foot from the throttle until the gear change has been effected.

In view of the foregoing disadvantages and limitations associated with known load-carrying vehicles, a commercial need exists for an improved load-carrying vehicle combination for use both aboveground and in underground mines that overcomes at least some of the abovementioned problems or provides the public with a useful alternative.

### SUMMARY OF THE INVENTION

Accordingly, the present invention discloses a control system for use in a vehicle having two or more engines with independent throttle controls that enables control of the vehicle, including a multi-combination vehicle or “road-train”, when the driver becomes ineffective and no longer in control of the vehicle.

This safety feature ensures that if the driver, for example, looses consciousness, the vehicle looses driving propulsion safely coming to rest rather than becoming a runaway vehicle, the dangers of that obvious.

According to one form of the present invention there is provided a system for the control of engines in a vehicle operable by a driver and having at least two engines, said system including: a first throttle control operating said first of two engines said throttle control operable by said driver between an idle position and a full throttle position; a second throttle control operating said second of said two engines and operable by said driver; a first throttle switch being in a closed position when said first throttle is in a predetermined position and being in an open position when in any other said position; a second engine control means wherein when said first throttle is in said predetermined position, said control means forces the second engine to idle independent of the position of said second throttle.

In a further form of the invention there is proposed a system for the control of engines in a vehicle operable by a driver and having at least two engines, said system including: a first throttle control operating said first of two engines said throttle control operable by said driver between an idle position and a full throttle position; a second throttle control operating said second of said two engines and operable by said driver; a first throttle sensor adapted to sense when the first throttle is not at a predetermined position; a control means adapted to force the second engine to idle when said first throttle position is not in the predetermined position.

In preference said system further includes a timing means wherein said second engine is forced to idle only when said first throttle is not in the predetermined position for a preset period of time.

Advantageously said preset period of time is greater than 6 seconds.

Advantageously said first throttle control is a biased pedal that is nominally in its idle position.

Advantageously said biased pedal is operable by a foot of the driver.

Advantageously said second throttle control is a hand throttle control operable between a first and a second position, wherein in said first position the second engine is caused to idle and in said second position said second engine is caused to be at full throttle, the hand throttle remaining in its operating position between said first and second positions independently of the operation of said first throttle, wherein when said system causes the second engine to idle due to the first throttle being not in a predetermined position greater than the preset amount of time, said second engine is caused to remain at idle regardless of the subsequent position of the first throttle.

Advantageously said system further includes a reset means, whereby control of said second engine is returned to said hand throttle only after said reset means has been activated.

Advantageously said reset means is a switch within said hand throttle, said switch being activated when said hand throttle is in a predetermined position.

Advantageously said hand throttle predetermined position is the first or idle position.

In a still further form of the invention there is proposed a multi-combination vehicle operable by a driver including: a powered towing unit having a first engine controlled by a first throttle, said first throttle being operable by said driver between a first and a second position; a power trailer, said powered towing unit and said power trailer being mechanically coupled to one another in a series arrangement, said power trailer having a second engine controlled by a second throttle, said second throttle being operable by said driver independently of said first throttle; a first throttle switch being in a closed position when said first throttle is in a predetermined position and being in an open position when in any other said position; a second engine control means wherein when said first throttle is in said predetermined position, said control means forces the second engine to idle independent of the position of said second throttle.

Advantageously said predetermined position is the idle position.

Advantageously said second control means forces said second engine to idle only after said first throttle is in the predetermined position for a preset amount of time.

### BRIEF DESCRIPTION OF THE DRAWINGS

These and other features, aspects, and advantages of the present invention will become better understood with regard to the following description, appended claims and accompanying drawings wherein:

FIG. 1 is a left side elevation of a multi-combination vehicle according to one embodiment of the present invention, with the vehicle incorporating several vehicle trailers and several power trailers;

FIG. 2 is a front perspective view of a power trailer included in the multi-combination vehicle according to the present invention;

FIG. 3 is a rear perspective view of the power trailer of FIG. 2;

FIG. 4 is a right hand side elevation view of the power trailer shown in FIG. 2;

FIG. 5 is a left side elevation of the power trailer shown in FIG. 2;

FIG. 6 is a left side elevation view of a multi-combination vehicle according to an alternative embodiment of the present invention;

FIG. 7 is a perspective view illustrating an electronic throttle control according to the present invention;

FIG. 8 is a schematic circuit diagram of the system of the present invention;

FIG. 9 is a schematic circuit diagram of a further embodiment of the present invention including a latching system where said hand throttle has to be reset before becoming operable; and

FIG. 9 is a typical flow chart of the logic of the preset invention.

### DESCRIPTION OF THE PREFERRED EMBODIMENT

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts.

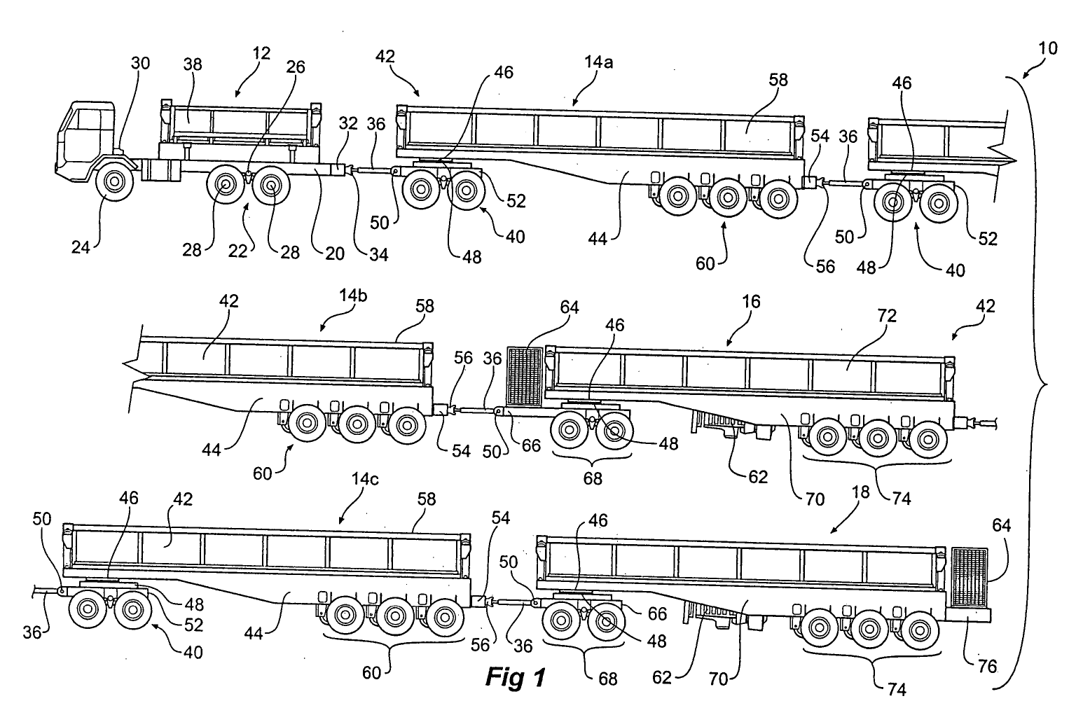

Turning now to the drawings in detail there is shown in FIG. 1 a multi-combination vehicle 10 including a truck 12 mechanically coupled to a plurality of trailers 14. A power trailer 16 extends from forwardly located trailers 14a and 14b and a further trailer 14c is coupled to the power trailer 16. A second power trailer 18 is coupled to the last trailer 14c. It is however to be understood that the multi-vehicle combination may include one or more power trailers, depending on the application.

The truck 12 includes a chassis or frame 20 and a rear axle assembly 22, which is suspended from and disposed below the chassis 20. Forward axle 24 comprises the steering axle of the truck 12. The rear axle assembly 22 is suspended from chassis 20 via suspension 26 and includes wheeled axles 28. Both of the wheeled axles may be driving axles, or alternatively only one is a driving axle. The driving axles may be a tridem axle assembly in lieu of the tandem axle assembly 22 and possibly suspended with a mechanical suspension.

The truck 12 further includes a motive power source 30 and a transmission (not shown) for transmitting torque from the motive power source 30 to the drive axles 28. Typically the motive power source comprises a diesel engine and the transmission for transmitting torque from the engine 30 to the drive axles 28 includes a gear box, a drive shaft, and a differential (not shown). Alternatively, the motive power source 30 may comprise other types of internal combustion engines utilising a variety of fuels.

The truck includes a draw frame 32 attached and rearwardly extending from the chassis 20. A coupling 34 is attached to the rear of the draw frame 32 and connected with a drawbar 36 on the trailer 14a. A bin 38 accommodates payload to be carried by the truck and may be adapted to be side tipping by being hingedly attached to the frame 20 (not shown).

Each of the trailers 14a, 14b, and 14c includes a converter dolly 40 and a semi-trailer 42, said semi-trailer having a chassis 44, a forward end with a coupling system 46 that pivotably attaches to a ball-race turntable 48 on the converter dolly. This enables the converter dolly to pivot relative to the semi-trailer about a generally vertical axis of rotation passing through the centre of the ball-race turntable. Other embodiments may however equally well be used, such as an oscillating ball-race turntable or a grease plate. The drawbar 36 is hingedly connected through pivot 50 to the chassis 52 of the converter dolly 40 and accommodates for any change in the grade of the road surface. As with the truck, the trailers 14a, 14b, and 14c, further include draw frames 54 attached and rearwardly extending from the chassis 44. A coupling 56 is attached to the rear of the trailer draw frames 54 and is connected with a drawbar 36 on the next trailer or power trailer. A bin 58 accommodates payload to be carried by the trailer and may be adapted to be side-tipping by being hingedly attached to the frame (not shown). Each trailer includes a rear axle assembly 60 typically having three axles, the mechanical details of which are well known in the art.

Power trailer 16 is coupled to trailer 14b using coupling arrangements as described above. The power trailer 16 includes the same mechanical features as with the other non-powered trailers 14a, 14b, and 14c, such as semi-trailer 42, with the addition of an engine 62 suspended generally half-way along chassis 70 and a cooling means 64 located at the front of the power trailer 16 positioned to take into account the movement necessary during a turn. Extending the chassis 66 of the power trailer dolly 68 enables the addition of the cooling means 64. Alternatively, although not shown, the cooling means 64 may be accommodated on the front of the chassis 70 of the power trailer by shortening the bin 72 when compared with the bin 58 of a non-powered trailer. A transmission system provides motive power to the rear axle assembly 74 of the power trailer 16.

Power trailer 18 also includes engine 62 mechanically coupled to the rear drive axle assembly 74 but includes the cooling means 64 located at the rear of the power trailer thereby eliminating the requirement for the extra length in the chassis of the dolly as was the case in power trailer 16 and instead extending the rear 76 of the chassis 70 to support the cooling means 64.

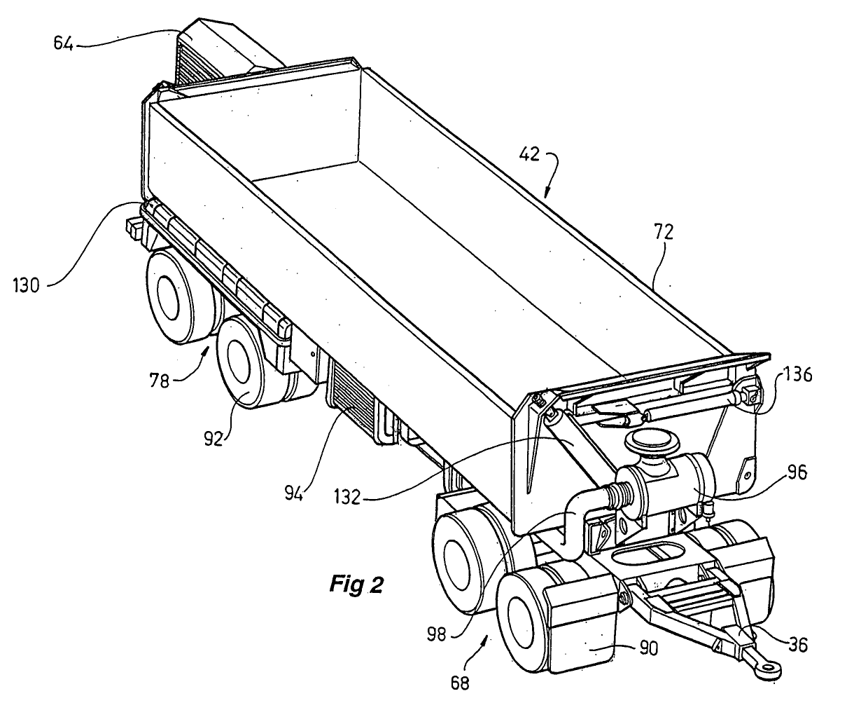

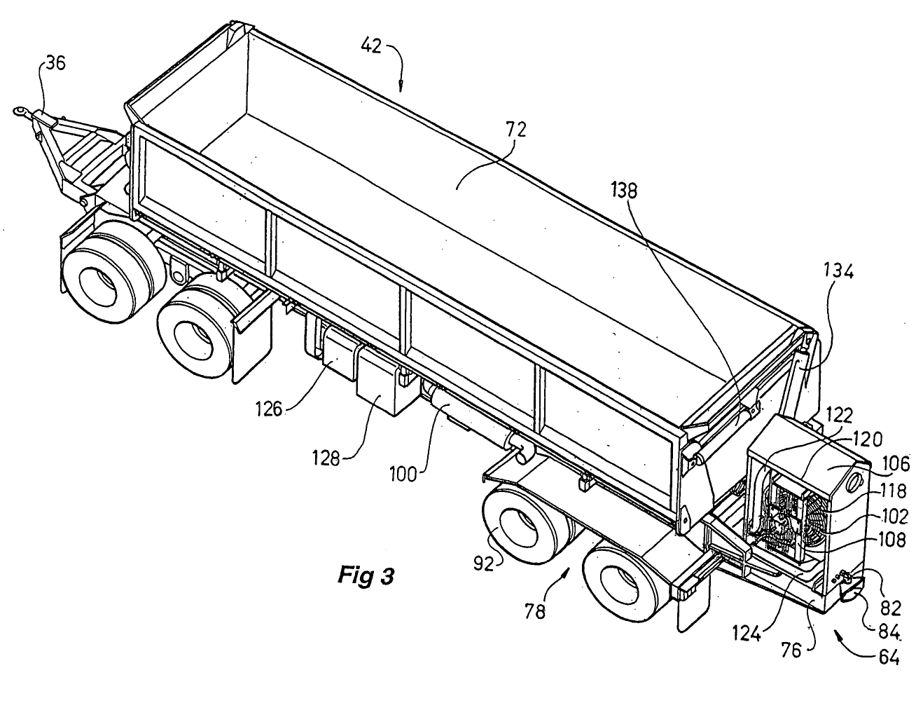

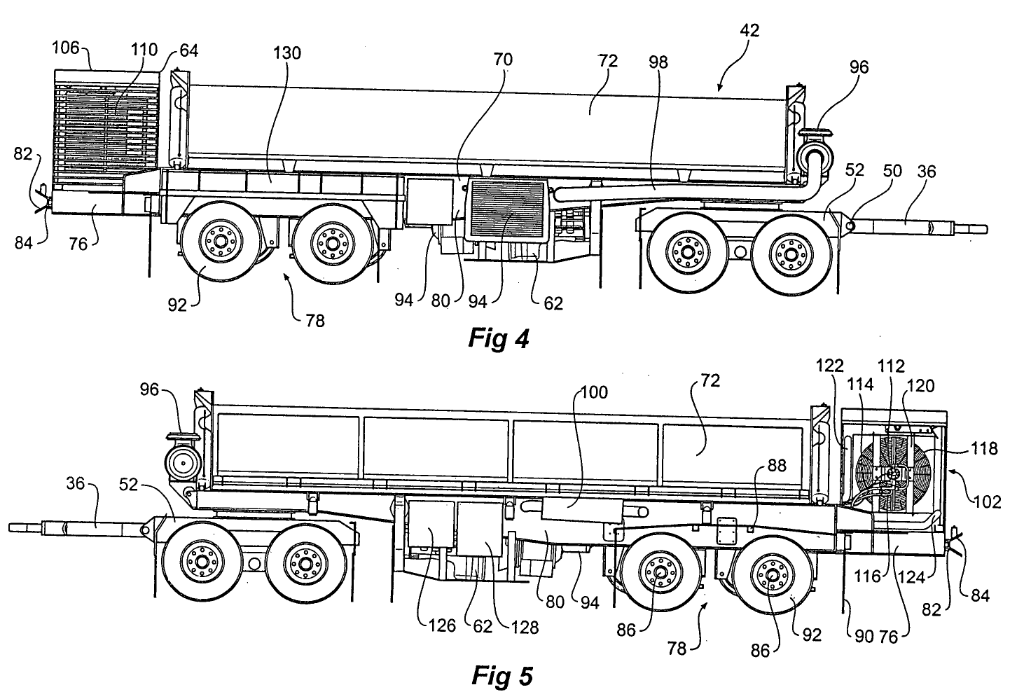

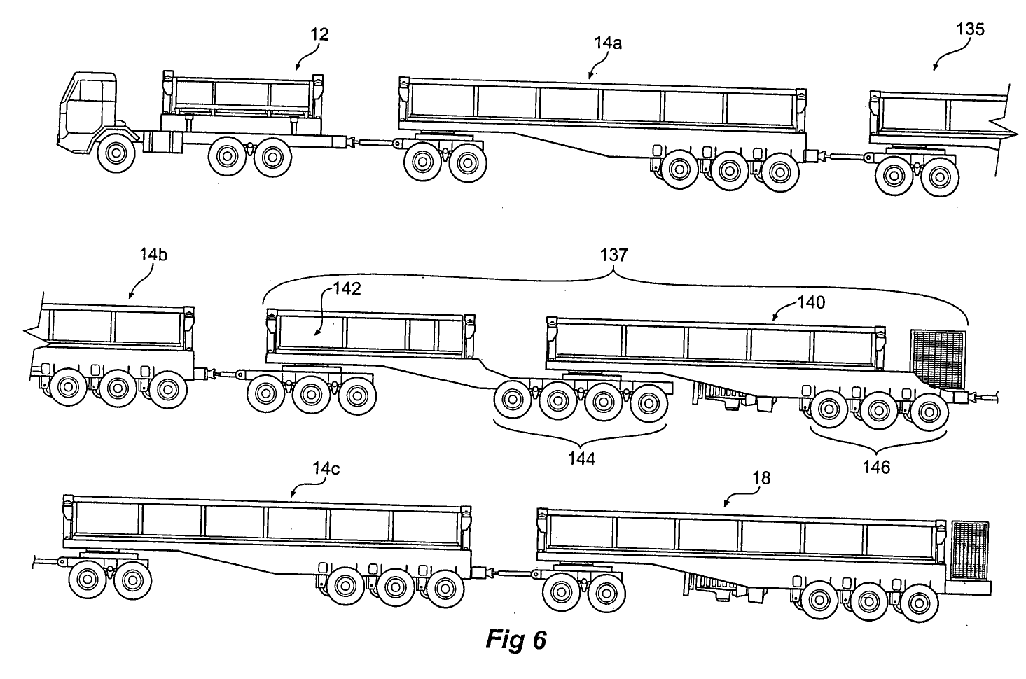

Referring to FIGS. 2-5, there is illustrated a power trailer such as power trailer 18 having the cooling means 64 at the rear end thereof but having a double axle rear axle assembly 78. The power trailer includes semi-trailer 42 having a chassis 70 including a rear extension 76. The chassis 70 includes a pair of longitudinally extending side members 80 and a plurality of transverse cross-members (not shown) interconnecting and attached to the side members 80. The rear axle assembly 78 is suspended from chassis 70 typically by air suspension (not shown). Alternatively the semi-trailer 42 may include a conventional mechanical spring assembly. The side members 80 support or form part of the load carrying structure such as bin 72. The load carrying structure may be a side tipping trailer, a stock crate, a fuel tank, or any other type of structure for supporting a load. As with the truck and non-powered trailers, the power trailer includes a draw frame 82 attached and rearwardly extending from the chassis 70. A coupling 84 is attached to the rear of the draw frame 82 and connected with a drawbar 36 on the next trailer or power trailer and may be adapted to be side-tipping by being hingedly attached to the chassis 70 (not shown).

The rear axle wheel assembly 78 includes wheeled axles 86. Extending above said wheeled axles are members 88 that may be used to support mudguards and the like 90. The wheeled axles 86 include a plurality of tires 92 mounted thereon for supporting the semi-trailer as it travels over a road surface.

Mounted within chassis 70 is a motive power source or engine 62 suspended generally centrally between the side members 80 and centrally within the chassis 70. A transmission 94 provides driving power from the engine 62 to the axle assembly 78 where one or more of the wheeled axles 86 may be driven. The engine is typically a diesel engine and may be advantageously include a turbocharger (not shown). To be able to fit the engine 62 in between the side members 80, the separation between the side members 80 is generally larger than that conventionally found on existing semi-trailers. However, the standard width of the wheeled axles is kept the same to keep the vehicle roadworthy. This has necessitated mounting the power trailer suspension under the side members rather than on their side. The engine 62 is supplied with combusting air through an air inlet 96. The air is then fed through to the engine via air pipe 98 and through appropriate filters. Exhaust gases are vented from the engine through exhaust outlet 100.

The cooling means 64 includes a radiator 102 to assist in cooling the engine by using an appropriate cooling fluid or coolant. In this particular advantageous embodiment the engine cooling means or the radiator 102 is mounted at the rear of the power trailer on top of frame extension 76 that extends further rearwardly from the chassis 70. Typically, the length of the frame would be extended to accommodate the radiator positioned along the frame. However, the frame may very well remain the same length as in conventional trailers, but the length of the bin 72 would be shortened to provide sufficient space to accommodate the radiator.

The radiator 102 includes coolant coils mounted in a housing 106. An air fan 108 is mounted behind coils and is driven to draw air through the coils. Located in front of the coils is a grill 110 to offer some protection to the coils from damage by debris. The air fan 108 typically includes a hydraulic motor 112 driven by the supply of hydraulic fluid through conduits 114 and 116. The air fan 108 is also housed in a protective grill 118 and is supported in position by support bars 120 extending between the top and bottom of the housing 106.

Coolant is supplied to the radiator through inlet pipe 122 and back to the engine through outlet pipe 124. The significant distance between the radiator and the engine means that the length of pipes transporting the coolant is quite long. This in itself provides an advantage in that the volume of coolant for the engine system has been greatly increased as compared to conventional engine designs where the radiator is located in front of the engine. The volume of the pipes effectively acts as a large coolant store.

Located around the engine are various compartments 126 and 128 that house the necessary control and sensing equipment for the engine such as engine starting controls and diagnostic instruments. Typically these systems include communication means with the truck so that the driver is kept advised as to the general status of the power trailer engine.

Power trailer fuel tanks 130 are located above the right hand side of the rear axle assembly 78 and act as pseudo mudguards. Side-tipping hydraulic arms 132 and 134 are provided at the front and rear of the bin respectively whilst arms 136 and 138 control opening the side of the bin 72.

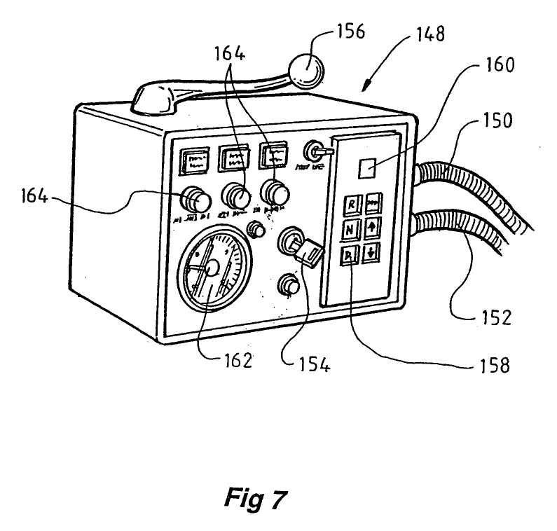

FIG. 6 illustrates a multi-combination vehicle 135 wherein instead of a power-trailer as illustrated earlier, there is at least one “B-double” trailer 137 incorporating a power trailer 140 coupled to a trailer 142. The trailer 142 includes a rear axle assembly 144 that acts as a dolly for the power trailer 140. Power trailer 140 includes a tri-axle rear axle assembly 146, the configuration of the other components being similar to those described earlier and well known in the art. Rear axle assembly 144 is a quad-axle assembly. It is however to be understood that the assembly may have less axles than shown, such as a tri-axle assembly. A B-double trailer 137 configuration has been found to provide improved directional stability. In the case of a long multi-combination vehicle, this enables the operator to assemble a multi-combination vehicle having a total combination of approaching up to 10 trailers and power trailers.

The above description illustrates a multi-combination vehicle 135 having multiple power trailers and a single prime mover or truck. We now discuss the throttle control systems of such a multi-combination vehicle. For ease of understanding we will discuss an embodiment where there is only one truck and one power trailer. It is however to be understood that the control system may equally well apply to one or more power trailers and it is not intended to limit the present application to a multi-combination vehicle having only one power trailer.

It is further to be understood that the control system the subject of the present invention relates to a multi-combination vehicle of the type where the truck and the power trailer throttle controls are independent of each other. Such an arrangement would typically be used where the truck transmission is a manual type one whilst the trailer is an automatic one. Since a driver would not be able to control manual transmission systems of two engines, the transmission system of the power trailer is an automatic one. However, it is not intended to limit the multicombination vehicle to a truck of the manual transmission type. The present invention may be used in a multicombination vehicle where the truck and power trailer both have an automatic transmission and where the throttle controls are separate. For brevity, the following description assumes that the truck utilises a manual transmission.

Each of the engines includes engine on-board computer management systems, which not only measure a number of parameters such as the torque, fuel injected, and the engine rpm's (revolutions per minute) but also enable a throttle input to drive the engine.

The throttle for the truck is typically an electronic pedal where the amount of throttle provided to the engine is proportional to the depression of the pedal. Such a throttle is typically biased so that it requires a constant force to keep the throttle in the one position. Of course there are cruise control system that may be employed to keep the truck running at a preset speed or preset fuel consumption.

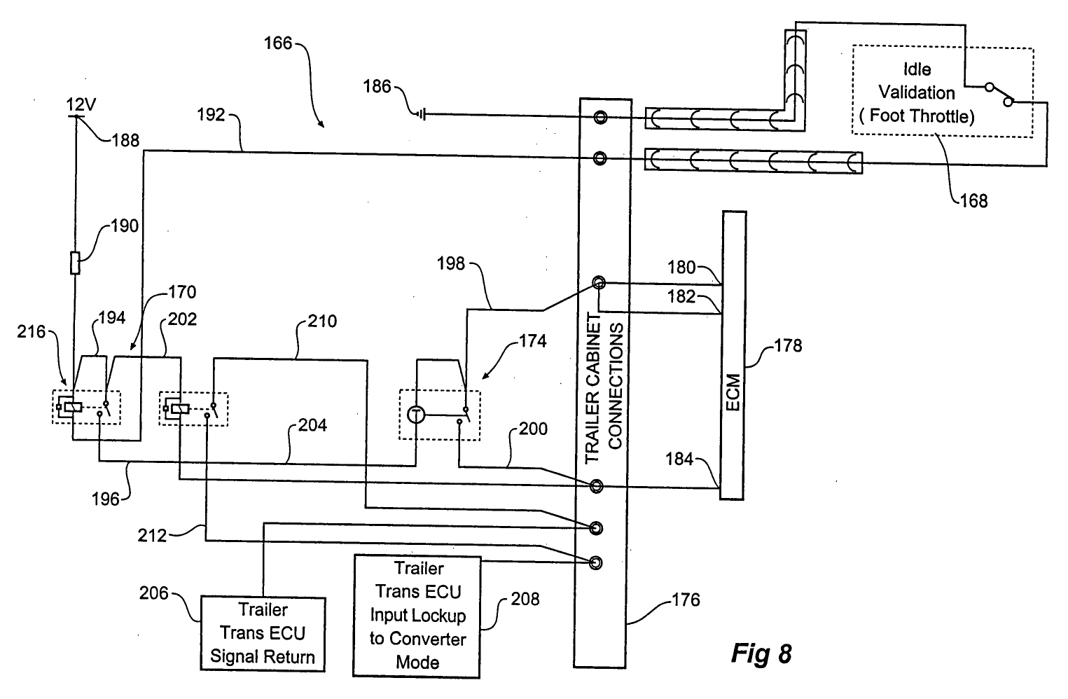

The control system 148 for the power trailer engine is located within easy reach of the driver's hand and is illustrated in FIG. 7. The control system 148 communicates with the power trailer engine via cables 150 and 152.

Located on the control system 148 is a trailer ignition key 154 and hand throttle 156 as well as a transmission control pad 158 having a display 160 and enabling the driver to control the automatic transmission as is well known in the art.

The control system 148 includes diagnostic indicators such as a tachometer 162 and various visual indicators such as lamps 164 provide a visual warning to the driver if, for example, the oil temperature, water temperature and air pressure are not in the acceptable range.

The hand throttle control 156 is a pivotable variable throttle lever, between a first position setting the engine speed to idle and in a second position running the engine “flat-out”. The lever remains in its location until operated by the driver, that is, it is not biased to the idle position.

Those skilled in the art would appreciate the difficulty of controlling such a multi-combination vehicle where there are separate throttles and typically the power trailer engine is operated assuming a load all the time, that is, “flat out”. This operating condition is fine when the multicombination vehicle is travelling at its desired speed but is not appropriate when the vehicle is slowing down of working at a smaller rate. At that time, the driver is able to simultaneously operate both the foot throttle for the control of the truck engine and the hand throttle for the control of the power trailer engine. Over time an experienced driver can drive such a multicombination vehicle without any difficulties.

However, as discussed earlier, there is a serious safety problem to consider where the driver may become incapacitated where, for example, they may loose consciousness. When a driver looses consciousnesses they no longer exert a force with their foot on the standard throttle pedal of the truck, the truck engine then simply idling. However, the power trailer engine (or the second engine) is independently controlled by a hand throttle and that engine continues to run as preset by the hand throttle propelling the vehicle even when the driver is no longer in control.

Accordingly, the present invention provides for a system where when the driver or operator of the multicombination vehicle no longer operates the throttle pedal, the second engine is also de-throttled, that is, it is forced to idle even though its throttle control is via an independent throttle.

In a further aspect of the invention, this forced idle of the power trailer engine only occurs after a driver is no longer applying a force on the throttle pedal only after a predetermined period has elapsed. The reason for this delay is in the case where the driver's foot may, for example, slip from the throttle pedal, or the driver is changing gears on a manual transmission truck, where during the gear change the driver takes their foot of the throttle pedal anyway. Unde those conditions the driver usually applies throttle to the truck engine within a relatively short period of time during which the trailer engine can continue to run in its form without causing and safety concerns.

The preset period is therefore calculated to give sufficient time for a driver to change gears, but not too much time so that if the driver is unconsciousness, the trailer engine is forced to idle. Typically this period is set to some 6 seconds.

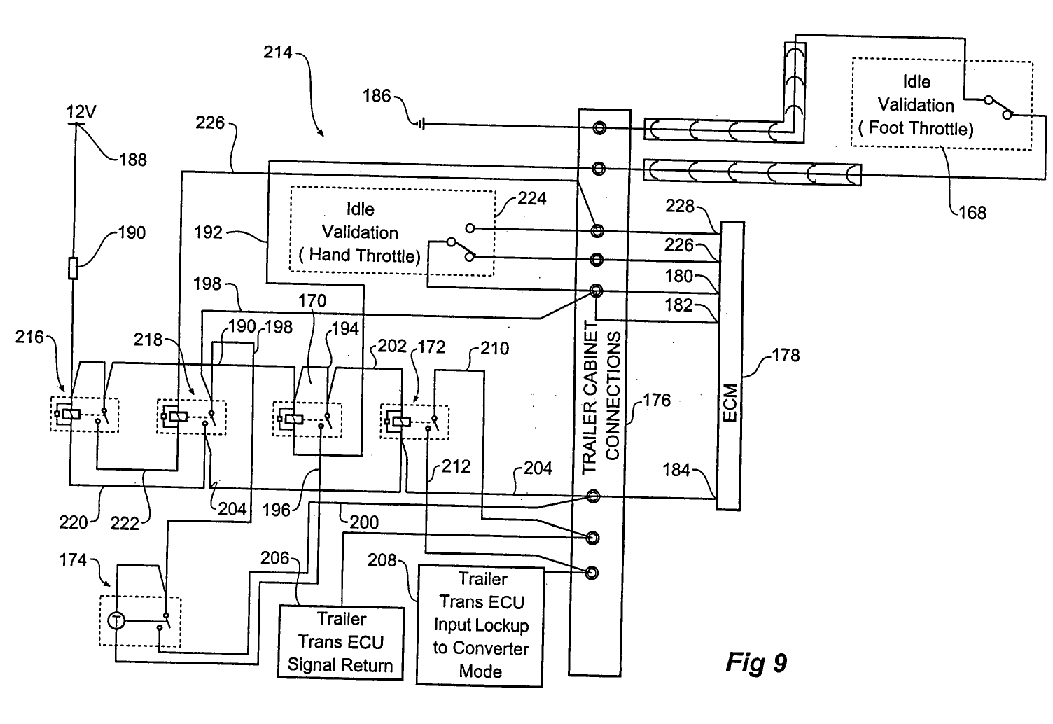

The circuit illustrated in FIG. 8 and discussed in more detail later provides the forced idle condition when the driver has taken their foot off the throttle pedal and including a timer to effect a forced idle of the trailer engine after a predetermined period of time.

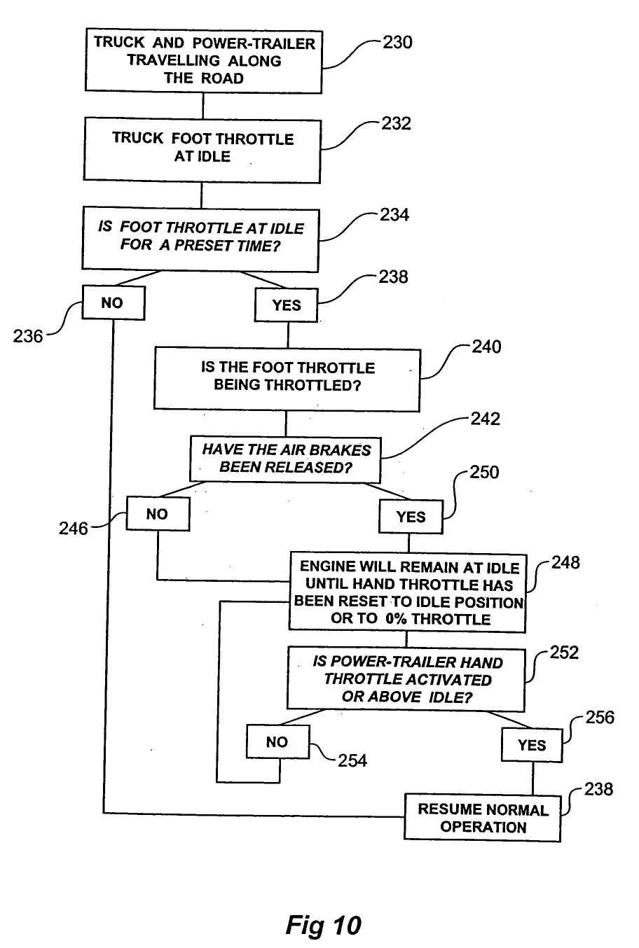

It may also be desirable that once the trailer engine has been forced to idle it remains in that condition until the driver effectively resets it. An example of how this may be achieved using a forced idle validation switch is illustrated in FIG. 9 where once the forced idle has been activated due to the driver taking their foot off the throttle for a predetermined period of time, the trailer engine remains in the forced idle position until the hand throttle is brought back to the idle position at which time the circuit is reset enabling the trailer engine to be once again powered up, that is, controlled by the hand throttle. That is, once the circuit has been activated, the hand throttle is inactive even when the driver reapplies throttle to the truck engine until the hand throttle is brought back to a predetermined position at which point the circuit controlling the forced idle is deactivated. Typically this requires the hand throttle to be brought back to the idle position that then enables the operator to power up the power trailer engine as normal.

Of course, to prevent damage to the power trailer transmission, as soon as the power trailer engine is brought to forced idle, the trailer automatic transmission is forced from a lock-up mode or direct drive mode to a torque converter mode to quickly release power and prevent the power trailer engine from stalling.

Referring now specifically to FIG. 8 there is provided a control circuit 166 for the forced idle condition as described above. The circuit 166 includes an idle validation or foot throttle switch 168, a first relay 170, second relay 172, timer relays 174, trailer cabinet connection 176, and ECM (Engine Control Management) 178. The ECM is well known in the art and is common in current engines with typical engines providing numerous inputs and outputs from the engine. Thus the ECM 178 includes ground outputs 180 and 182 and input 184 that enables the operator to force the engine to idle.

It is to be understood that the configuration of the ECM illustrated in FIG. 8 is to be representative only and that various engines may very well have different ECM configurations. It is however to be assumed that all engine ECM's will be able to have a force idle input as well as a ground output.

Idle validation switch 168 is nominally in the closed position only when the foot throttle is in the idle position, at other times the switch being open. When in the closed position, as illustrated in FIG. 8 the switch 168 provides ground 186 to relay 170. In this case relay 170 is also always provided a positive 12 Volt supply 188 that is the standard power supply in vehicles, typically through fuse 190. Thus when the relay 170 is fed ground through electrical connection 192 from foot throttle switch 168 when it is closed (that is the foot throttle is in the idle position) it operates to close its switch which then provides positive 12 Volt power to timer relay 174 through connections 194 and 196, these connection made by the switch in the relay 170.

However, timer relay 174 is also electrically connected through connection 198 to the ground 180 and 182 from the ECM. Accordingly, after a preset amount of time, relay 174 energises closing its switch that than connects the ECM ground output 180 and 182 to forced idle input 184 through electrical connection 200. This then forces the trailer engine to idle. The timer relay 174 may be pre-programmed to be independent of driver control. However, the driver may very well be provided with some flexibility. For example, the driver may have variable control over the timer to increase or decrease the preset time between a range of, for example, 4-10 seconds.

Whilst the above-described circuit forces the trailer engine to idle if the driver takes their foot of the throttle pedal after a preset amount of time, to ensure that there is no damage to the transmission, relay 172 is used to convert the transmission from lockup to converter mode. Thus one side of relay 172 is always provided positive power 188 through bridging connection 202. The other side of the relay is electrically connected through connection 204 to the ECM input 184 and thus to relay 174 connection 200. When input 184 is grounded due to relay 174 activating, a ground is also provided to relay 172 thereby energising it and making its switch that than makes contact between the trailer transmission electronic control unit (ECU) 206 and trailer transmission ECU Input Lockup to converter mode 208 through connections 210 and 212 respectively.

Thus it should now be apparent that the system of the present invention provides the operator with the safety feature that if for whatever reason the driver does not throttle the main engine for a predetermined time, the trailer engine is forced to go to idle mode. In addition, the trailer engine transmission system is forced to go to a safe or converter mode.

As a further safety feature and according to a second aspect of the invention, once the trailer engine has been directed to idle, the invention provides for a system whereby the circuit has to be reset regardless of the operation of the foot throttle. That is, if the driver throttles the main engine, the trailer engine remains in the idle condition until the circuit is reset. This circuit 214 is illustrated in FIG. 9 to which we now refer.

The basic configuration of the circuit and elements 168 to 212 is identical to that illustrated in FIG. 8. There are however two additional relays being relays 216 and 218. Relay 216 is always provided positive 12 Volts 188 on one side and is electrically connected through connection 220 to the ECM 178 input 184. That is, when ground is supplied to the input 184 by virtue of the throttle being disengaged as described above after a preset amount of time, this relay is energised providing positive power to relay 218 through connection 222. The other side of relay 218 is connected through idle validation switch 224 using electrical connection 226.

Switch 224 as illustrated in FIG. 9 is in its rest position, that is, when the hand throttle is at idle, that information then provided through to the ECM on-idle input 226. However when the hand throttle is being throttled, or above a preset amount, switch 224 makes a connection between the ECM ground outputs 180 and 182 through connection 226 to relay 218. It also supplies this information to ECM off-idle input 228. The application of a ground and positive 12 Volts to relay 218 energise it making the switch that then connects ground 198 (that is also connected to timer relay 174) to ECM input 184 through connection 204 that is also extended to relay 218.

The skilled addressee will now appreciate that relay 218 acts as a latching relay in that it will continue to provide a ground to ECM input 184 regardless of the status of relays 170 and 174. That is, even if the driver throttles the foot pedal, breaking switch 168 and causing relay 170 to de-energise (there no longer being a potential difference), ground is still going to be provided from the ECM output 180 and 182 through relay 218 to ECM input 184 that then also supplies ground to relay 216 that keeps relay 218 in its energised position. Thus when the driver throttles the main engine, the circuit is still latched when the hand-throttle is in the “on” position.

To therefore break this contact, it is necessary that the idle validation switch is activated or reset so that ground is no longer provided through connection 226 to relay 218 causing it to de-energise and no longer supply ground to input 184. This ground is then no longer supplied to relay 216 that is also de-energised so that even if the hand-throttle switch 224 is then activated the circuit is in its rest position until ground is provided to relay 216 through timer relay 174.

This then enables the trailer engine to be operated via the hand throttle as normal.

FIG. 10 is a flow chart illustrating the logic behind the throttle operation of the two engines according to the present invention.

In a multi-combination vehicle travelling along a road (block 230) where one of the engines (such as the truck) is controlled by a normal foot throttle pedal and the other by another control (such as the power trailer), usually hand controlled, when the driver takes their foot off the throttle (block 232), a determination is made if the foot throttle has been at idle (that is, inactive) for more than a preset amount of time (block 234), typically 6 seconds in a multi-combination vehicle involving a truck and power trailer.

If the throttle has been at idle for less than that time, that is No (block 236), the power trailer engine continues running normally (block 238). If the throttle has been idle for more than the preset time (block 238) than the second or trailer engine is forced to an idle position whilst at the same time its transmission is disconnected (block 240).

A determination is then made if the foot throttle is being activated (block 242). If No (block 246) then the trailer engine remains at idle until the hand throttle has been reset to its idle position or 0% throttle (block 248). Even if Yes (block 250) the engine is still at idle until the hand throttle is reset. Of course the reset position need not be the idle position and it may even be in some cases that the engine needs to be completely switched off to reset the hand throttle control.

A determination is then made if the hand throttle has been activated or above idle (block 252). If No (block 254) the engine will remain at idle until it is activated (block 252). If Yes (block 256) then the driver can resume normal operation. That is, the second engine is being throttled and the driver can safely operate the first engine and the multi-combination vehicle.

In summary the present invention provide the safety feature that the driver must have his foot on the normal truck throttle in order for the power trailer to operate normally when the power trailer is hand throttle controlled. If the truck driver fails to throttle the engine for a set period, it forces the trailer to idle.

Those skilled in the art will appreciate that the present invention complements and further enhances the multi-combination vehicles whose details were described in the United States and International Applications discussed earlier and that provide significant advantages and cost savings when hauling ore.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

1. A system for the control of a vehicle operable by a driver, the vehicle including at least independent first and second engines, said system including:
a first throttle control in communication with said first engine, said first throttle control being operable by said driver between a first idle position and a first full throttle position;
a second throttle control in communication with said second engine, said second throttle control being operable by said driver between a second idle position and a second full throttle position;
a first throttle switch having a closed positions said closed position being engaged when said first throttle control is in a first predetermined position;
an engine control in communication with said second engine, said engine control being adapted to force said second engine to an engine idle condition independent of said operable positions of said second throttle when said first throttle is in said first predetermined position.

2. A system for the control of a vehicle operable by a driver, the vehicle including at least independent first and second engines, said system including:
a first throttle control in communication with said first engine, said first throttle control being operable by said driver between an idle position and a full throttle position when said driver applies at least a first force to said first throttle control;
a second throttle control in communication with said second engine, said second throttle control being operable by said driver between a second idle position and a second throttle position;
a throttle sensor in communication with said first throttle control, said throttle sensor being adapted to detect said first force being applied to said first throttle control;
an engine control in communication with said throttle sensor and said second engine, said engine control being adapted to force said second engine to an engine idle condition independent of said operable positions of said second throttle control when said throttle sensor detects that said first force is not being applied to said first throttle control.

3. The system of claim 2, further including a timing means for timing at least a first period of time when said throttle sensor continuously detects that said first force is not being applied to said first throttle control, said timing means being in communication with said engine control, wherein when said first force is not applied to said first throttle control for said first period of time said second engine is forced to said engine idle condition.

4. The system of claim 3, wherein said first period of time is greater than 6 seconds.

5. The system of claim 2, wherein said first throttle control comprises a biased pedal that is nominally in an idle position.

6. The system of claim 4, wherein said biased pedal is operable by a foot of said driver.

7. The system of claim 2, wherein said second throttle control comprises a hand throttle control operable between a first and a second position, wherein in said first position said second engine is forced to said engine idle condition and in said second position said second engine is caused to be at a full throttle condition, said hand throttle remaining in its operating position between said first and second positions independently of the operation of said first throttle control, wherein when said system causes said second engine to be in said engine idle condition due to said first force not being applied to said first throttle control greater than said first period of time, said second engine is caused to remain in said engine idle condition regardless of the subsequent position of said first throttle control.

8. The system of claim 7, wherein said system includes a reset means for disengaging said second engine from said forced engine idle condition, said reset means being in communication with said second throttle control, whereby control of said second engine is returned to said second throttle control only after said reset means has been activated.

9. The system of claim 8, wherein said reset means comprises an electronic switch, said switch being positioned whereby said switch is activated when said second throttle control is moved to a second predetermined position.

10. The system of claim 9, wherein said second predetermined position comprises said second idle position.

11. A multi-combination vehicle operable by a driver, comprising:
a powered towing unit having a first engine controlled by a first throttle, said first throttle being operable by said driver between a first and a second position;
a power trailer, said powered towing unit and said power trailer being mechanically coupled to one another in a series arrangement, said power trailer having a second engine controlled by a second throttle, said second throttle being operable by said driver independently of said first throttle;
a throttle switch having a closed position, said closed position being engaged when said first throttle is in a predetermined position;
an engine control in communication with said second engine, said engine control being adapted to force said second engine to an idle condition independent of said operable positions of said second throttle when said first throttle is in said predetermined position.

12. The multi-combination vehicle of claim 11, wherein said predetermined position comprises said first position.

13. The multi-combination vehicle of claim 11, wherein said engine control forces said second engine to said idle condition after said first throttle is in said predetermined position for a preset period of time.

14. The system of claim 1, wherein said system includes timing means for timing the length of time said first throttle control is in said first predetermined position.

15. The system of claim 14, wherein said timing means is in communication with said engine control, wherein when said first throttle control is in said first predetermined position for a first period of time said second engine is forced to said engine idle condition.

16. The system of claim 1, wherein said second throttle control includes reset means for disengaging said second engine from said forced engine idle condition when said second throttle control is moved to a second predetermined position.

17. The multi-combination vehicle of claim 9, wherein said switch is disposed proximate to said second throttle control.

18. The multi-combination vehicle of claim 9, wherein said switch is an integral component of said second throttle control.

19. The multi-combination vehicle of claim 11, wherein said power trailer includes a transmission having a drive mode and a torque converter mode.

20. The multi-combination vehicle of claim 19, wherein said second engine is forced to said idle condition, said power trailer transmission is forced to said torque converter mode.

21. The multi-combination vehicle of claim 12, wherein said first position comprises an idle position.
